(19) United States
(12) Patent Application Publication
(10) Pub. No.: US 2025/0133356 A1
(43) Pub. Date: Apr. 24, 2025

(54) EAR-WEARABLE ELECTRONIC DEVICE INCLUDING ELASTOMERIC LIGHT PIPE WITH INGRESS RESISTANCE FEATURES

(71) Applicant: Starkey Laboratories, Inc., Eden Prairie, MN (US)

(72) Inventors: Thaddeus Hoffman, Brooklyn Park, MN (US); Ganesh Borra, Minneapolis, MN (US); Tim Werts, Saint Louis Park, MN (US)

(21) Appl. No.: 18/906,751

(22) Filed: Oct. 4, 2024

Related U.S. Application Data
(60) Provisional application No. 63/545,306, filed on Oct. 23, 2023.

(51) Int. Cl. H04R 25/00

(52) U.S. Cl. CPC H04R 25/60; H04R 25/65

(57) ABSTRACT

An ear-wearable electronic device comprises a housing having a housing wall. The housing wall comprises an outer surface, an inner surface, and an aperture extending between the outer and inner surfaces. A light emitting device is disposed in the housing. An elastomeric light pipe is disposed within the aperture and arranged to receive light from the light emitting device. An interface between a section of the housing wall comprising the aperture and the elastomeric light pipe defines a convoluted path for impeding passage of fluid between the outer and inner surfaces of the housing wall.

### CROSS REFERENCE TO RELATED APPLICATIONS

This application claims the benefit of 63/545,306, filed Oct. 23, 2023, the disclosure of which is incorporated by reference herein in its entirety.

### TECHNICAL FIELD

This application relates generally to ear-level electronic devices and systems, including hearing devices, personal amplification devices, hearing aids, bone conduction hearing devices, medical and consumer hearables, in-ear electronic appliances, electronic ear plugs, physiologic monitoring devices, biometric devices, and other ear-wearable electronic devices.

### SUMMARY

Some embodiments are directed to an ear-wearable electronic device comprising a housing having a housing wall. The housing wall comprises an outer surface, an inner surface, and an aperture extending between the outer and inner surfaces. A light emitting device is disposed in the housing. An elastomeric light pipe is disposed within the aperture of the housing wall and arranged to receive light from the light emitting device. An interface between a section of the housing wall comprising the aperture and the elastomeric light pipe defines a convoluted path for impeding passage of fluid between the outer and inner surfaces of the housing wall.

Some embodiments are directed to an ear-wearable electronic device comprising a housing having a housing wall. The housing wall comprises an outer surface, an inner surface, and an aperture extending between the outer and inner surfaces. A light emitting device is disposed in the housing. An elastomeric light pipe is disposed within the aperture of the housing wall and configured to receive light from the light emitting device. The elastomeric light pipe comprises an outer section exposed to an environment external of the housing, a flange in abutment with the inner surface, and an intermediate section extending from the outer section to the flange. The intermediate section and a section of the housing wall comprising the aperture are configured to define a convoluted path for impeding passage of fluid between the outer and inner surfaces of the housing wall.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 illustrates a representative ear-wearable electronic device which incorporates a light emitting device optically coupled to an elastomeric light pipe in accordance with any of the embodiments disclosed herein.

FIG. 2 is an enlarged view of a portion of the ear-wearable electronic device shown in FIG. 1.

FIG. 3 illustrates a representative ear-wearable electronic device which incorporates a light emitting device optically coupled to an elastomeric light pipe in accordance with any of the embodiments disclosed herein.

FIG. 4 illustrates details of an elastomeric light pipe optically coupled to a light emitting device in accordance with any of the embodiments disclosed herein.

FIG. 5 illustrates details of an elastomeric light pipe optically coupled to a light emitting device in accordance with any of the embodiments disclosed herein.

FIG. 6 illustrates details of an elastomeric light pipe optically coupled to a light emitting device in accordance with any of the embodiments disclosed herein.

FIG. 7 is an enlarged view of a portion of FIG. 6 showing details of an elastomeric light pipe in accordance with any of the embodiments disclosed herein.

FIG. 8 illustrates a gasket member which incorporates an integral elastomeric light pipe in accordance with any of the embodiments disclosed herein.

FIG. 9 illustrates an installation tool for installing an elastomeric light pipe in an aperture of a housing wall of an ear-wearable electronic device in accordance with any of the embodiments disclosed herein.

FIGS. 10A-10B are views of an elastomeric light pipe with representative dimensions in accordance with any of the embodiments disclosed herein.

FIG. 11 is a block diagram of a representative ear-wearable electronic device which can incorporate an elastomeric light pipe and light emitting device in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to any ear-wearable or ear-level electronic device without departing from the scope of this disclosure. The devices depicted in the figures are intended to demonstrate the subject matter, but not in a limited, exhaustive, or exclusive sense. Ear-wearable electronic devices, such as hearables (e.g., ear monitors, earbuds, electronic earplugs), hearing aids, hearing instruments, and hearing assistance devices, typically include an enclosure, such as a housing or shell, within which internal components are disposed. Typical components of an ear-wearable electronic device can include a processor (e.g., a digital signal processor or DSP), memory circuitry, power management and charging circuitry, one or more communication devices (e.g., one or more radios, a near-field magnetic induction (NFMI) device), one or more antennas, one or more microphones, buttons and/or switches, and a receiver/speaker, for example. Ear-wearable electronic devices can incorporate a long-range communication device, such as a Bluetooth® transceiver or other type of radio frequency (RF) transceiver. In some implementations, a communication facility (e.g., a radio or NFMI device) of an ear-wearable electronic device can be configured to facilitate communication between a left hearing device and a right hearing device of a hearing device system.

Some embodiments are directed to hearing devices that can aid a person with impaired hearing. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to an ear-wearable electronic device, which is understood to refer to a system comprising a single left ear device, a single right ear device, or a combination of a left ear device and a right ear device.

A conventional ear-level electronic device, such as a hearing device, may communicate different states of the device to the wearer through audio output. Audio output alone provides insufficient information to the wearer or a caregiver (e.g., a hearing professional) in a variety of circumstances. When fitting a new hearing device to a wearer, for example, audio output from the hearing device cannot be perceived by the caregiver. As such, the caregiver may be unaware of the device status (e.g., programming status, Bluetooth connectivity status) while fitting the new hearing device to the wearer.

In some cases, different states of a conventional ear-level electronic device may be communicated to the wearer via an app executed by a mobile electronic device (e.g., a smartphone). Such communication with the ear-level electronic device, however, requires the wearer to have access to the mobile electronic device, which may not be possible in some instances. Also, the wearer must have sufficient training to use the app executed by the mobile electronic device, which may be challenging for less sophisticated users.

Embodiments of the disclosure are directed to an ear-wearable electronic device which incorporates a light emitting device optically coupled to an elastomeric light pipe with ingress resistance features. The light emitting device and elastomeric light pipe are arranged to provide a visual indication as to the status of the ear-wearable electronic device. For example, visual indications of device programming status, Bluetooth pairing status, state of charge status, and device malfunctions can be communicated to the wearer via the light emitting device and elastomeric light pipe arrangement.

Inclusion of a light emitting device in the ear-wearable electronic device requires an opening in the device housing in order for light to be transmitted to the external environment. Such an opening, however, provides a potential ingress path for fluids (e.g., water) to pass into the interior of the device housing. An elastomeric light pipe of the present disclosure incorporates ingress resistance features which mitigate the ingress of fluid passing through an opening in the device housing. The elastomeric light pipe communicates light produced by the light emitting device to the external environment, providing visual indications to the wearer as to the status of the device.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. An ear-wearable electronic device comprises a housing having a housing wall comprising an outer surface, an inner surface, and an aperture extending between the outer and inner surfaces. A light emitting device is disposed in the housing, and an elastomeric light pipe is disposed within the aperture and arranged to receive light from the light emitting device. An interface between a section of the housing wall comprising the aperture and the elastomeric light pipe defines a convoluted path for impeding passage of fluid between the outer and inner surfaces of the housing wall.

Example Ex2. The device according to Ex1, wherein the elastomeric light pipe comprises a first retention feature and the section of the housing wall comprising the aperture comprises a second retention feature configured to receive the first retention feature.

Example Ex3. The device according to Ex2, wherein the first retention feature of the elastomeric light pipe comprises a snap-fit feature.

Example Ex4. The device according to Ex2 or Ex3, wherein the first retention feature comprises one or more recessed regions of the elastomeric light pipe, and the second retention feature comprises one or more protruding regions of the section of the housing wall comprising the aperture.

Example Ex5. The device according to one or more of Ex1 to Ex4, wherein the elastomeric light pipe comprises a solid elastomeric member.

Example Ex6. The device according to one or more of Ex1 to Ex5, wherein the elastomeric light pipe comprises a thermoplastic elastomeric material or a thermoset elastomeric material.

Example Ex7. The device according to one or more of Ex1 to Ex6, comprising a plurality of lap joints formed between the housing wall section comprising the aperture and the elastomeric light pipe.

Example Ex8. The device according to Ex7, wherein the plurality of lap joints comprises two-surface or three-surface lap joints.

Example Ex9. The device according to one or more of Ex1 to Ex8, wherein the elastomeric light pipe comprises a flange configured to form a compression axial seal with the inner surface of the housing wall.

Example Ex10. The device according to one or more of Ex1 to Ex9, comprising a spine disposed within the housing and configured to support components of the ear-wearable electronic device, wherein the light emitting device is disposed on a top surface of the spine that faces the inner surface of the housing wall, and the elastomeric light pipe is positioned over the light emitting device.

Example Ex11. The device according to one or more of Ex1 to Ex9, comprising a spine disposed within the housing and configured to support components of the ear-wearable electronic device, wherein the light emitting device is disposed in the housing proximate a cutout through the spine, and the elastomeric light pipe is positioned over the cutout.

Example Ex12. The device according to one or more of Ex1 to Ex11, wherein the light emitting device and the elastomeric light pipe are situated within or proximate a switch area of the housing.

Example Ex13. The device according to one or more of Ex1 to Ex12, comprising an elastomeric gasket member disposed between first and second sections of the housing, wherein the elastomeric light pipe is integral to the elastomeric gasket member. Example Ex14. An ear-wearable electronic device comprises a housing having a housing wall comprising an outer surface, an inner surface, and an aperture extending between the outer and inner surfaces. A light emitting device is disposed in the housing. An elastomeric light pipe is disposed within the aperture and configured to receive light from the light emitting device. The elastomeric light pipe comprises an outer section exposed to an environment external of the housing, a flange in abutment with the inner surface, and an intermediate section extending from the outer section to the flange, the intermediate section and a section of the housing wall comprising the aperture configured to define a convoluted path for impeding passage of fluid between the outer and inner surfaces of the housing wall.

Example Ex15. The device according to Ex14, wherein the flange is configured to form a compression axial seal with the inner surface of the housing wall.

Example Ex16. The device according to Ex14 or Ex15, wherein the intermediate section of the elastomeric light pipe comprises a first retention feature and the section of the housing wall comprising the aperture comprises a second retention feature configured to receive the first retention feature.

Example Ex17. The device according to Ex16, wherein the first retention feature comprises a snap-fit feature.

Example Ex18. The device according to Ex16 or Ex17, wherein the first retention feature comprises one or more recessed regions of the elastomeric light pipe, and the second retention feature comprises one or more protruding regions of the section of the housing wall comprising the aperture.

Example Ex19. The device according to one or more of Ex14 to Ex18, wherein the elastomeric light pipe comprises a solid elastomeric member.

Example Ex20. The device according to one or more of Ex14 to Ex19, wherein the elastomeric light pipe comprises a thermoplastic elastomeric material or a thermoset elastomeric material.

Example Ex21. The device according to one or more of Ex14 to Ex20, comprising a plurality of lap joints formed between the housing wall section comprising the aperture and the intermediate section of the elastomeric light pipe.

Example Ex22. The device according to Ex21, wherein the plurality of lap joints comprises two-surface or three-surface lap joints.

Example Ex23. The device according to one or more of Ex14 to Ex22, comprising a spine disposed within the housing and configured to support components of the ear-wearable electronic device, wherein the light emitting device is disposed on a top surface of the spine that faces the inner surface of the housing wall, and the elastomeric light pipe is positioned over the light emitting device.

Example Ex24. The device according to one or more of Ex14 to Ex22, comprising a spine disposed within the housing and configured to support components of the ear-wearable electronic device, wherein the light emitting device is disposed in the housing proximate a cutout through the spine, and the elastomeric light pipe is positioned over the cutout.

Example Ex25. The device according to one or more of Ex14 to Ex24, wherein the light emitting device and the elastomeric light pipe are situated within or proximate a switch area of the housing.

Example Ex26. The device according to one or more of Ex14 to Ex25, comprising an elastomeric gasket member disposed between first and second sections of the housing, wherein the elastomeric light pipe is integral to the elastomeric gasket member.

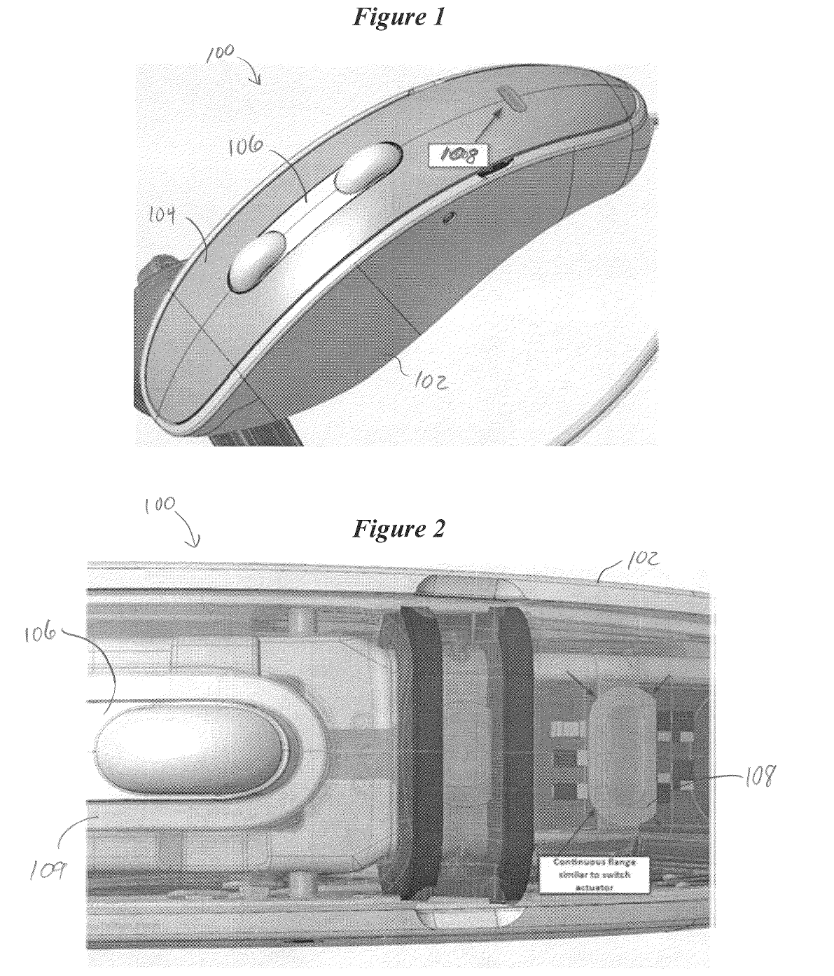

FIG. 1 illustrates a representative ear-wearable electronic device in accordance with any of the embodiments disclosed herein. The ear-wearable electronic device 100 shown in FIG. 1 is representative of the behind-the-ear component of a Receiver-In-Canal (RIC) hearing device. It is understood that embodiments of the disclosure are not limited to a specific type of ear-wearable electronic device (e.g., a RIC hearing device), but may be implemented in any ear-wearable electronic device including those listed hereinabove.

The ear-wearable electronic device 100 includes a housing 102 which is configured to rest behind an ear of the wearer. In this configuration, a RIC cable (not shown) is connected to the housing 102, at one end, and includes an earpiece, at the other end. The earpiece includes an acoustic transducer (e.g., a receiver) which produces audio output that is communicated through the wearer's ear canal to the eardrum.

The housing 102 shown in FIG. 1 includes a housing wall 104, which can define a cover to the housing 102. Protruding through the housing wall 104 is a switch actuator 106, which can be configured as a rocker switch in some implementations. An elastomeric light pipe 108 is disposed in the housing wall 104 and optically coupled to a light source (e.g., an LED) positioned within the housing 102. In the configuration shown in FIG. 1 and FIG. 2 (an enlarged view of the housing 102 shown in FIG. 1 with the housing wall 104 hidden), the elastomeric light pipe 108 is spaced apart from the switch actuator 106 in an anterior direction. Although a single elastomeric light pipe 108 is shown in FIGS. 1 and 2, it is understood that more than one elastomeric light pipe 108 can be incorporated in the housing 102.

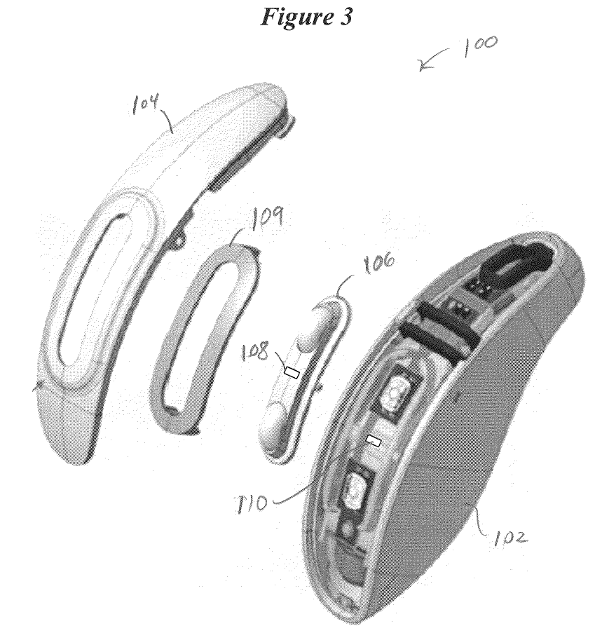

FIG. 3 illustrates another configuration of the ear-wearable electronic device 100 in accordance with any of the embodiments disclosed herein. FIG. 3 is an exploded view of the ear-wearable electronic device 100 which shows various components of the device 100. In the configuration shown in FIG. 3, the elastomeric light pipe 108 is positioned within the switch area of the housing 102. The elastomeric light pipe 108 can be disposed within a midsection of the switch actuator 106. As can be seen in FIG. 3, the elastomeric light pipe 108 is positioned above an LED 110 disposed within the housing 102. A gasket member 109 is disposed between the switch actuator 106 and the housing wall 104 which defines a cover of the housing 102.

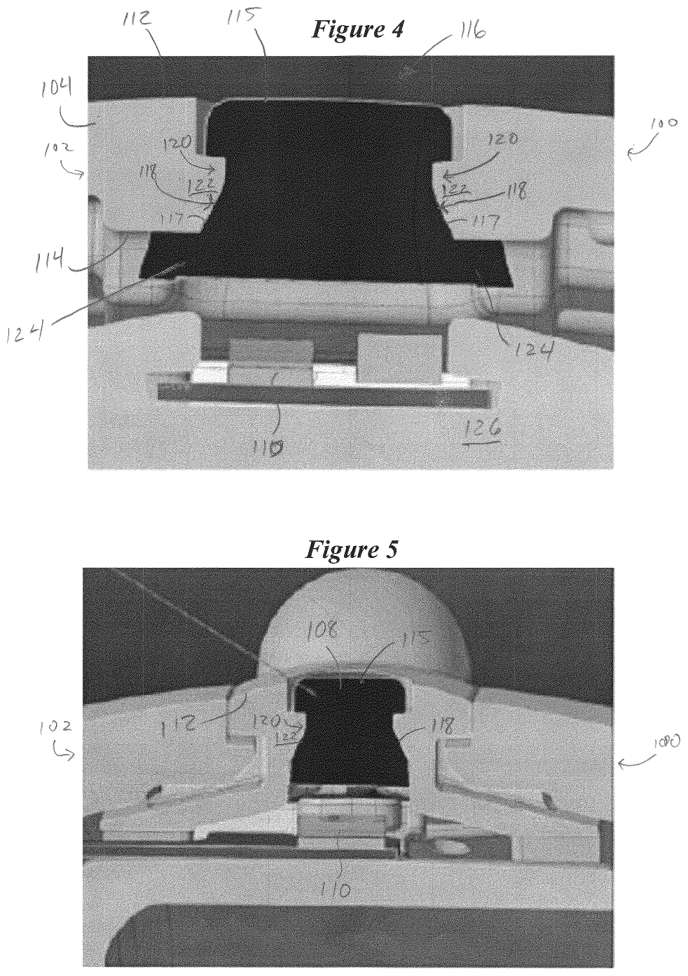

FIGS. 4 and 5 illustrate a portion of a representative ear-wearable electronic device 100 in accordance with any of the embodiments disclosed herein. FIG. 4 is a lateral cross-sectional view of the housing 102. FIG. 5 is a longitudinal cross-sectional view of the housing 102. FIGS. 4 and 5 show the elastomeric light pipe 108 disposed in the housing wall 104 of the ear-wearable electronic device 100. The housing wall 104 can be a cover of the housing 102. The portion of the housing wall 104 shown in FIGS. 4 and 5 includes an outer surface 112, an inner surface 114, and an aperture 116 extending between the outer surface 112 and the inner surface 114. The elastomeric light pipe 108 is disposed within the aperture 116 and arranged to receive light from the light emitting device 110 (e.g., an LED).

The elastomeric light pipe 108 shown in FIGS. 4 and 5 includes an outer section 115 which is exposed to an environment external of the housing 102. The elastomeric light pipe 108 also includes a flange 124 which abuts the inner surface 114 of the housing wall 104. In some configurations, the flange 124 forms a compression axial seal with the inner surface 114 of the housing wall 104. The elastomeric light pipe 108 further includes an intermediate section 117 which extends from the outer section 115 to the flange 124. The intermediate section 117 and the section of the housing wall 104 comprising the aperture 116 are configured to define a convoluted path (e.g., a tortuous path) for impeding passage of fluid between the outer and inner surfaces 112, 114 of the housing wall 104.

In some implementations, the convoluted path extends along at least 50% of the aperture 116 in the housing wall 104. In other implementations, the convoluted path extends along at least 60% of the aperture 116 in the housing wall 104. In further implementations, the convoluted path extends along at least 70% of the aperture 116 in the housing wall 104. In other implementations, the convoluted path extends along at least 80% of the aperture 116 in the housing wall 104.

The intermediate section 117 of the elastomeric light pipe 108 includes a first retention feature 120 comprising one or more recessed regions of the elastomeric light pipe 108. The first retention feature 120 can define a snap-fit feature of the elastomeric light pipe 108. The section of the housing wall 104 comprising the aperture 116 includes a second retention feature 122 configured to receive the first retention feature 120. The second retention feature 122 includes one or more protruding regions of the section of the housing wall 104 comprising the aperture 116. A snap-fit joint can be defined between the first retention feature 120 of the elastomeric light pipe 108 and the second retention feature 122 of the housing wall 104. In some configurations, one or more lap joints are formed between the section of the housing wall 104 comprising the aperture 116 and the intermediate section 117 of the elastomeric light pipe 108. The one or more lap joints can comprise two-surface or three-surface lap joints, for example.

In the configuration shown in FIGS. 4 and 5, the LED 110 is mounted on an internal framework or spine 126 that is contained within the housing 102 and upon which may be mounted various internal components of the ear-wearable electronic device 100. In the configuration shown in FIGS. 4 and 5, sufficient space is provided between the spine 126 and the housing wall 104 to accommodate the LED 110 (e.g., as in the configuration shown in FIG. 3). It is noted that the spacing between the spine 126 and the housing wall 104 can vary along the longitudinal axis of the housing wall 104. As shown, the LED 110 is mounted to a top surface of the spine 126 that faces the housing wall 104. The elastomeric light pipe 108 is positioned directly over the LED 110. At this location, the LED 110 can transmit light directly to the elastomeric light pipe 108.

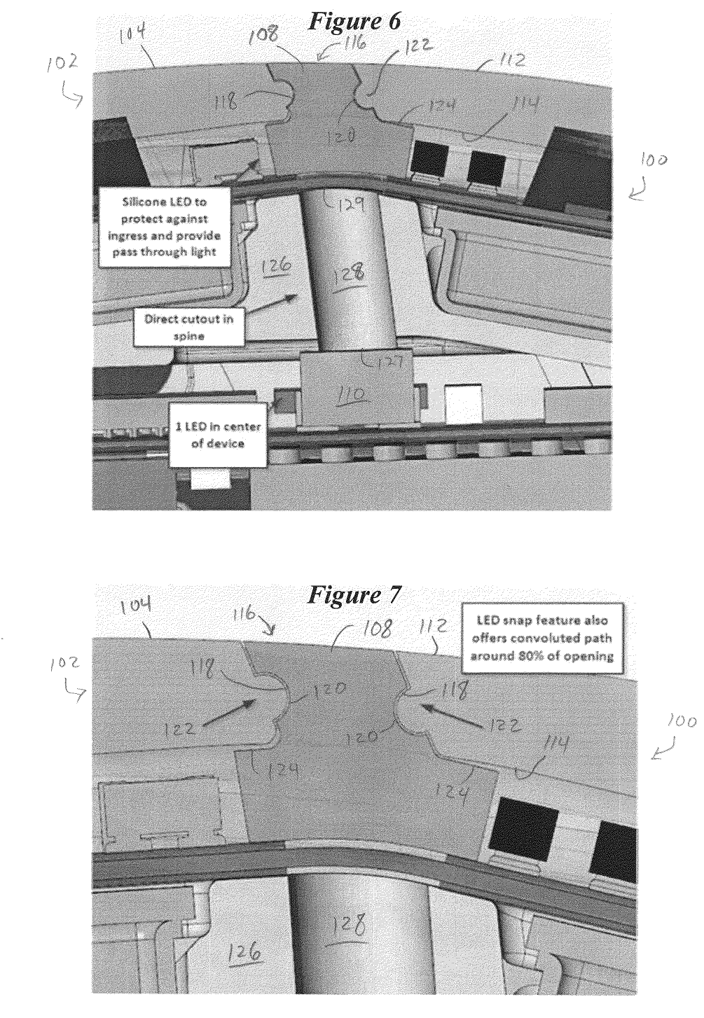

FIGS. 6 and 7 illustrate a portion of a representative ear-wearable electronic device 100 in accordance with any of the embodiments disclosed herein. FIG. 6 is a partial longitudinal cross-sectional view of the housing 102. FIG. 7 is an expanded view of FIG. 6 showing features of the elastomeric light pipe 108. The housing wall 104 of housing 102 includes an outer surface 112, an inner surface 114, and an aperture 116 extending between the outer and inner surfaces 112, 114. A light emitting device 110 (e.g., an LED) is disposed in the housing 102. The elastomeric light pipe 108 is disposed within the aperture 116 and arranged to receive light from the LED 110. An interface 118 between a section of the housing wall 104 comprising the aperture 116 and the elastomeric light pipe 108 defines a convoluted path for impeding passage of fluid between the outer and inner surfaces 112, 114 of the housing wall 104.

In some configurations, such as that shown in FIGS. 6 and 7, there is insufficient space provided between the spine 126 and the housing wall 104 to accommodate the LED 110 (e.g., as in the configuration shown in FIG. 1). As is shown in FIGS. 6 and 7, the LED 110 is disposed in the housing 102 below the spine 126. A cutout 128 (e.g., a void or via) is provided in the spine 126. A first end 127 of the cutout 128 is positioned above the LED 110. A second end 129 of the cutout 128 is positioned below the elastomeric light pipe 108. The cutout 128 is provided to facilitate transmission of light from the LED 110, through the spine 126, and to the elastomeric light pipe 108.

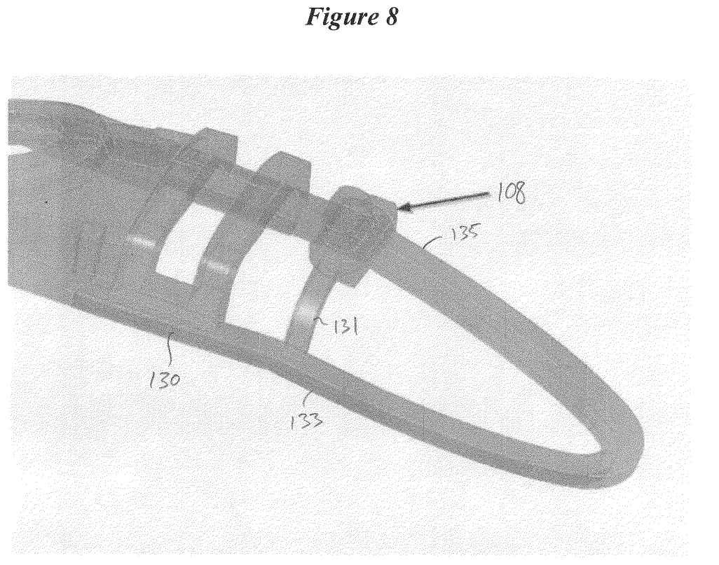

FIGS. 4-6 are directed to a housing 102 of an ear-wearable electronic device 100 which incorporates a discrete elastomeric light pipe 108. In some embodiments, the elastomeric light pipe 108 can be incorporated as an integral component of a gasket member. In some implementations, and as illustrated in FIG. 8, the gasket member 130 can be a full seam gasket member disposed between the housing 102 and the housing wall 104 (e.g., a cover of the housing 102). The gasket member 130 shown in FIG. 8 includes a first side 133 and an opposing second side 135. A support beam 131 is attached to, and extends between, the first and second sides 133, 135 of the gasket member 130. The support beam 131 includes an integral elastomeric light pipe 108. The integral elastomeric light pipe 108 can have a configuration similar or equivalent to that of the elastomeric light pipe 108 illustrated in FIGS. 4-7.

In other implementations, the elastomeric light pipe 108 can be an integral component of the gasket member 109 illustrated in FIG. 3. In such implementations, the gasket member 109 can incorporate a support beam which includes an integral elastomeric light pipe 108 in a manner similar to that shown in FIG. 8.

The elastomeric light pipe 108 disclosed herein can comprise a substantially transparent elastomeric material, which can be a thermoplastic or thermoset elastomeric material. Suitable thermoplastic elastomers include TPU (thermoplastic polyurethanes) and TPV (thermoplastic vulcanizates, such as EPDM-ethylene propylene diene monomer). A suitable thermoset elastomer is silicone. In some implementations, the elastomeric light pipe 108 can comprise a translucent elastomeric material.

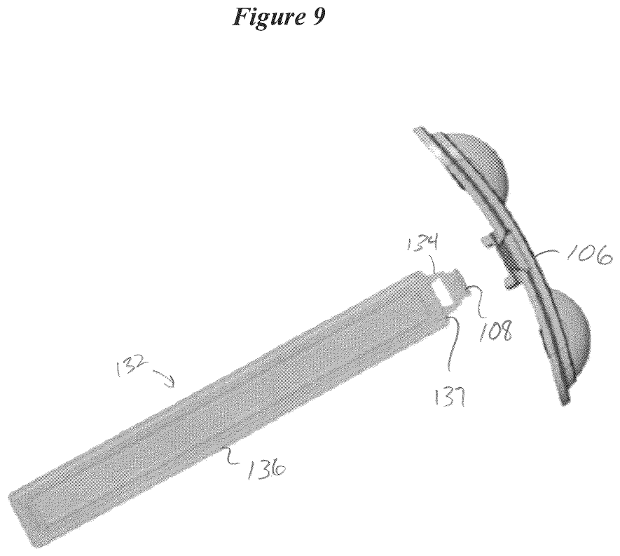

FIG. 9 illustrates an installation tool 132 configured to facilitate installation of an elastomeric light pipe 108 in an aperture of a switch actuator 106. The installation tool 132 includes a handle 136 which can be grasped and manipulated by a technician. A pair of prongs 134 are connected to, and support, the elastomeric light pipe 108 at a distal and 137 of the handle 136. Using the installation tool 132, the technician forces the elastomeric light pipe 108 into the aperture of the switch actuator 106. After installing the elastomeric light pipe 108 in the aperture of the switch actuator 106, the technician removes the installation tool 132 from the switch actuator 106, causing the elastomeric light pipe 108 to detach from the prongs 134 and leaving the elastomeric light pipe 108 in the aperture of the switch actuator 106.

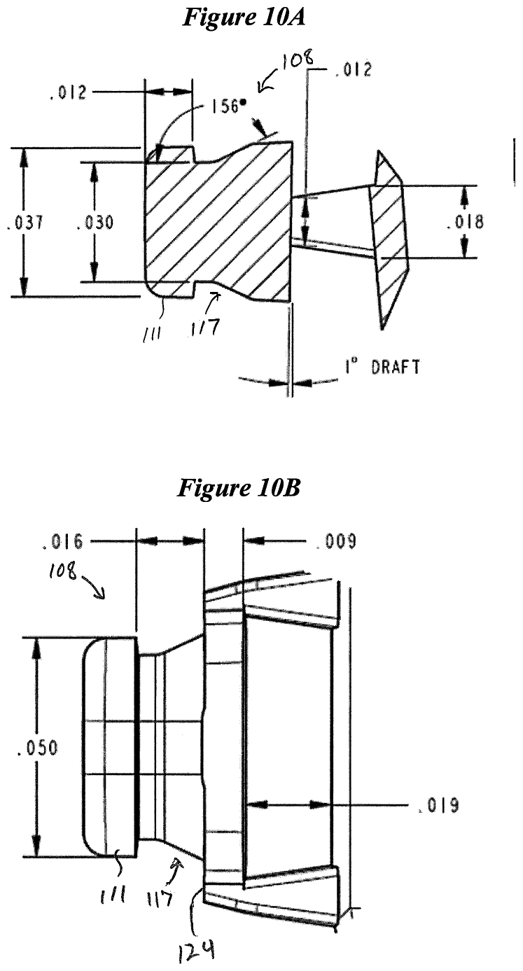

FIGS. 10A-10B are cross-sectional views of an elastomeric light pipe 108 with representative dimensions in accordance with any of the embodiments disclosed herein. The representative dimensions shown in FIGS. 10A-10B are given in inches. Representative dimensions are provided for the major structural features of the elastomeric light pipe 108, including a cap 111, an intermediate section 117, and a flange 124. It is understood that the representative dimensions shown in FIGS. 10A-10B are provided for illustration only, and that the elastomeric light pipe 108 can have dimensions that differ from those shown in FIGS. 10A-10B.

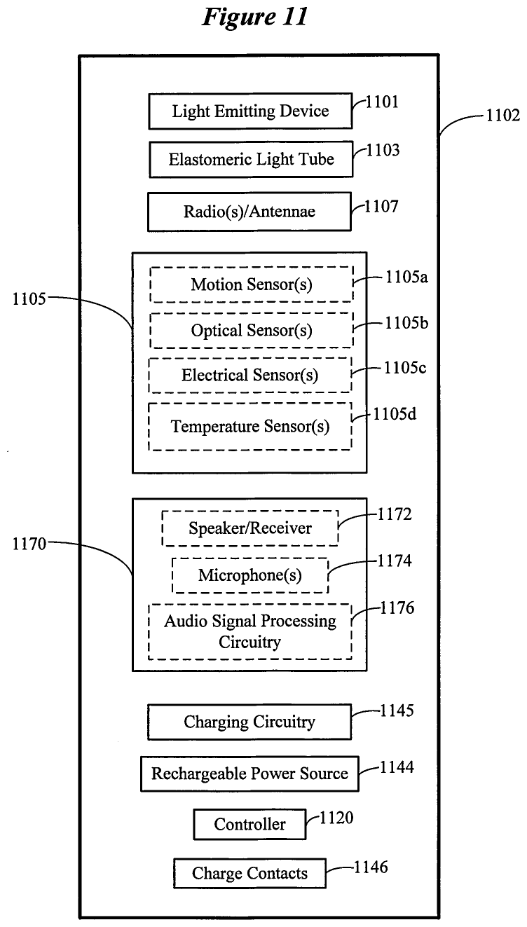

FIG. 11 is a block diagram of a representative ear-wearable electronic device 1102 which incorporates a light emitting device 1101 and an elastomeric light pipe 1103 in accordance with any of the embodiments disclosed herein. The device 1102 is representative of a wide variety of electronic devices configured to be deployed in, on or about an ear of a wearer, including any of the devices discussed hereinabove. The device 1102 can include one or more RF radios/antennae 1107 (e.g., compliant with a Bluetooth® or IEEE 802.11 protocol). The RF radios/antennae 1107 can be configured to effect communications with an external electronic device, communication system, and/or the cloud. The device 1102 includes a controller 1120, a rechargeable power source 1144, charging circuitry 1145, and charge contacts 1146.

The device 1102 can include one or more sensors 1105. For example, the device 1102 can include a motion sensor 1105a, one or more optical physiologic and non-physiologic sensors 1105b, one or more physiologic electrode-based sensors 1105c, and/or one or more temperature sensors 1105d.

The device 1102 includes an audio processing facility 1170. The audio processing facility 1170 includes audio signal processing circuitry 1176 coupled to an acoustic transducer 1172 (e.g., speaker, receiver, bone conduction device) and to one or more microphones 1174.

According to some embodiments, the device 1102 can be implemented as a hearing assistance device that can aid a person with impaired hearing. For example, the device 1102 can be implemented as a monaural hearing aid or a pair of devices 1102 can be implemented as a binaural hearing aid system. The monaural device 1102 or a pair of devices 1102 can be configured to effect bi-directional communication (e.g., wireless communication) of data with an external source, such as a remote server via the Internet or other communication infrastructure. The device or devices 1102 can be configured to receive streaming audio (e.g., digital audio data or files) from an electronic or digital source. Representative electronic/digital sources (e.g., accessory devices) include an assistive listening system, a streaming device (e.g., a TV streamer or audio streamer), a remote microphone, a radio, a smartphone, a laptop or other electronic device that serves as a source of digital audio data, control and/or settings data or commands, and/or other types of data files.

The controller 1120 can include one or more processors or other logic devices. For example, the controller 1120 can be representative of any combination of one or more logic devices (e.g., multi-core processor, digital signal processor (DSP), microprocessor, programmable controller, general-purpose processor, special-purpose processor, hardware controller, software controller, a combined hardware and software device) and/or other digital logic circuitry (e.g., ASICs, FPGAs), and software/firmware. The controller 1120 can incorporate or be coupled to various analog components (e.g., analog front-end), ADC and DAC components, and Filters (e.g., FIR filter, Kalman filter). The controller 1120 can incorporate or be coupled to memory. The memory can include one or more types of memory, including ROM, RAM, SDRAM, NVRAM, EEPROM, and FLASH, for example.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed subject matter may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality.

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. An ear-wearable electronic device, comprising:
a housing comprising a housing wall, the housing wall comprising an outer surface, an inner surface, and an aperture extending between the outer and inner surfaces;
a light emitting device disposed in the housing; and
an elastomeric light pipe disposed within the aperture and arranged to receive light from the light emitting device, an interface between a section of the housing wall comprising the aperture and the elastomeric light pipe defining a convoluted path for impeding passage of fluid between the outer and inner surfaces of the housing wall.

2. The device according to claim 1, wherein the elastomeric light pipe comprises a first retention feature and the section of the housing wall comprising the aperture comprises a second retention feature configured to receive the first retention feature.

3. The device according to claim 2, wherein the first retention feature of the elastomeric light pipe comprises a snap-fit feature.

4. The device according to claim 2, wherein:
the first retention feature comprises one or more recessed regions of the elastomeric light pipe; and
the second retention feature comprises one or more protruding regions of the section of the housing wall comprising the aperture.

5. The device according to claim 1, wherein the elastomeric light pipe comprises a solid elastomeric member.

6. The device according to claim 1, wherein the elastomeric light pipe comprises a thermoplastic elastomeric material or a thermoset elastomeric material.

7. The device according to claim 1, comprising a plurality of lap joints formed between the housing wall section comprising the aperture and the elastomeric light pipe.

8. The device according to claim 1, wherein the elastomeric light pipe comprises a flange configured to form a compression axial seal with the inner surface of the housing wall.

9. The device according to claim 1, comprising a spine disposed within the housing and configured to support components of the ear-wearable electronic device, wherein:
the light emitting device is disposed on a top surface of the spine that faces the inner surface of the housing wall; and
the elastomeric light pipe is positioned over the light emitting device.

10. The device according to claim 1, comprising a spine disposed within the housing and configured to support components of the ear-wearable electronic device, wherein:
the light emitting device is disposed in the housing proximate a cutout through the spine; and
the elastomeric light pipe is positioned over the cutout.

11. The device according to claim 1, wherein the light emitting device and the elastomeric light pipe are situated within or proximate a switch area of the housing.

12. The device according to claim 1, comprising an elastomeric gasket member disposed between first and second sections of the housing, wherein the elastomeric light pipe is integral to the elastomeric gasket member.

13. An ear-wearable electronic device, comprising:
a housing comprising a housing wall, the housing wall comprising an outer surface, an inner surface, and an aperture extending between the outer and inner surfaces;
a light emitting device disposed in the housing; and
an elastomeric light pipe disposed within the aperture and configured to receive light from the light emitting device, the elastomeric light pipe comprising:
an outer section exposed to an environment external of the housing;
a flange in abutment with the inner surface; and
an intermediate section extending from the outer section to the flange, the intermediate section and a section of the housing wall comprising the aperture configured to define a convoluted path for impeding passage of fluid between the outer and inner surfaces of the housing wall.

14. The device according to claim 13, wherein the flange is configured to form a compression axial seal with the inner surface of the housing wall.

15. The device according to claim 13, wherein the intermediate section of the elastomeric light pipe comprises a first retention feature and the section of the housing wall comprising the aperture comprises a second retention feature configured to receive the first retention feature.

16. The device according to claim 15, wherein the first retention feature comprises a snap-fit feature.

17. The device according to claim 15, wherein:
the first retention feature comprises one or more recessed regions of the elastomeric light pipe; and
the second retention feature comprises one or more protruding regions of the section of the housing wall comprising the aperture.

18. The device according to claim 13, wherein the elastomeric light pipe comprises a solid elastomeric member.

19. The device according to claim 13, wherein the elastomeric light pipe comprises a thermoplastic elastomeric material or a thermoset elastomeric material.

20. The device according to claim 13, comprising a plurality of lap joints formed between the housing wall section comprising the aperture and the intermediate section of the elastomeric light pipe.

21. The device according to claim 13, comprising a spine disposed within the housing and configured to support components of the ear-wearable electronic device, wherein:
the light emitting device is disposed on a top surface of the spine that faces the inner surface of the housing wall; and
the elastomeric light pipe is positioned over the light emitting device.

22. The device according to claim 13, comprising a spine disposed within the housing and configured to support components of the ear-wearable electronic device, wherein:
the light emitting device is disposed in the housing proximate a cutout through the spine; and
the elastomeric light pipe is positioned over the cutout.

23. The device according to claim 13, wherein the light emitting device and the elastomeric light pipe are situated within or proximate a switch area of the housing.

24. The device according to claim 13, comprising an elastomeric gasket member disposed between first and second sections of the housing, wherein the elastomeric light pipe is integral to the elastomeric gasket member.
